(19) United States
(12) Patent Application Publication
(10) Pub. No.: US 2015/0363885 A1
(43) Pub. Date: Dec. 17, 2015

(54) TECHNIQUES AND SYSTEMS FOR MANAGING INVESTMENT AND INSURANCE POLICIES

(71) Applicant: Steven Charles Leisher, San Diego, CA (US)

(72) Inventor: Steven Charles Leisher, San Diego, CA (US)

(21) Appl. No.: 14/741,343

(22) Filed: Jun. 16, 2015

Related U.S. Application Data
(60) Provisional application No. 62/012,967, filed on Jun. 16, 2014.

(51) Int. Cl. G06Q 40/08

(52) U.S. Cl. CPC G06Q 40/08

(57) ABSTRACT

Methods, systems, and devices are disclosed for managing investment and insurance policies. In one aspect, a method for managing a life insurance policy includes receiving information associated with a permanent life insurance policy and its policy holder, analyzing the information to generate a rating value of the permanent life insurance policy, and determining if the rating value is above a minimum threshold value to admit the permanent life insurance policy into a policy optimization portfolio. The method can also include creating financial value of the policy optimization portfolio by obtaining investment funding from a financial institution based on a cash value of the admitted permanent life insurance policies, investing at least some of the investment funding in one or more financial markets to receive a financial return, and determining a distribution of the financial return to provide to the policy holder and the financial institution.

### CROSS-REFERENCE TO RELATED APPLICATIONS

This patent document claims the benefits and priority of U.S. Provisional Patent Application No. 62/012,967, entitled “TECHNIQUES AND SYSTEMS FOR MANAGING INVESTMENT AND INSURANCE POLICIES,” filed on Jun. 16, 2014. The entire content of the aforementioned patent application is incorporated by reference as part of the disclosure of this application.

### TECHNICAL FIELD

This patent document relates to financial service technologies and systems, including computerized systems, devices, and processes for managing investment and insurance policies.

### BACKGROUND

An insurance policy is an agreement between an insurer party and an insured party providing protection or compensation against occurrence of a prescribed event. Insurance may come in many forms, covering various types of property, liability or credit, annuities, and the health or the life of the insured party, among other types of eventualities. The insured can include an individual or a business that makes payments to the insurer party, e.g., typically a company, which promises to pay money if the insured event has occurred. Insurance allows the insured party to manage the risk of loss due to the possible event occurring, e.g., effectively transferring at least a portion the risk of loss to the insurer in exchange for payment of insurance premiums.

Life insurance is a contract between an insured individual and/or policy holder (i.e., the life insurance policy holder) and the insurer party (i.e., the life insurance company), in which the insurer promises to pay a designated beneficiary of the insured a benefit (i.e., a sum of money) in exchange for a premium upon the death (or other agreed-upon event) of the insured individual. Life insurance policies include protection policies and investment policies. Protection life insurance policies can be designed as “term” insurance policies, where the life insurance coverage lasts for a specified term in exchange for a premium. Term life insurance policies do not accumulate any cash value for the insured, and the insurer may invest the premiums for their own financial gain or loss.

Investment life insurance policies, also referred to as permanent life insurance policies, are designed to facilitate the growth of capital by regular or single premiums. Investment life insurance policy accumulates a cash value, which is available to the insured and effectively reducing the risk to which the life insurance company is exposed, and thus the insurance expense over time. The life insurance policy holder can access money in the cash value by withdrawing the money, borrowing against the cash value, or in some examples, surrendering the policy and receiving the surrender value. Examples of investment life insurance policies include whole life, universal life, index universal life, and variable life policies.

In whole life insurance, a level premium is exchanged for the lifetime death benefit coverage. Whole life insurance policies include a term component that pays a certain amount (the face amount) of the policy to the beneficiary upon death of the insured individual (policy holder) and an investment component that builds a cash value that is accessible to the policy holder at any time through policy loans or withdrawals and are received income tax free. The cash value is kept in reserve, which is part of the policy and guaranteed by the life insurance company. Any unpaid amount of the policy loans at the time of death of the policy holder are generally subtracted from the death benefit paid out to the beneficiary. Also, with a typical whole life insurance policy, the death benefit is limited to the face amount specified in the policy, such upon reaching the endowment age or death of the policy holder, the face amount is all that is paid out to the designated beneficiary. Thus, with either death or endowment, the insurance company keeps any cash value built up over the years. Notably, while premiums of whole life insurance policies are much higher than term life insurance policies for policy holders at younger ages, the premiums of the term insurance premiums rise with age at each renewal such that premiums of the whole life insurance policies are generally lower if begun at the relatively younger ages.

There are several forms of whole life insurances policies. For example, some whole life insurance policies that pay dividends to the policy holder on a semi-annual or annual basis, which are classified as dividend-paying or dividend-participating whole life insurance. Typically, dividend-paying whole life insurance policies provide returns on the investments conducted by the insurance company (e.g., investing the premiums of the policy holders) in the form of a dividend. In some instances, dividend-paying policies may include a non-taxable return to the policy holder as income, e.g., which can be provided as cash, applied against future premium payments, savings to accumulate interest, used to buy pay-up additions, etc. In the event of a dividend paying whole life policy, the policy holder may have elected paid up additions which has an additional cash value component that the policy holder has access to as well.

Universal life insurance is a relatively new permanent life insurance product that includes some aspects of whole life insurance coverage, but with greater flexibility in premium payment, and in some forms, flexibility also in death benefits. Yet with flexibility of setting the premiums and death benefit comes with the disadvantage of reduced guarantees on both. Also, for example, when a universal life insurance policy holder increases the death benefit, the policy may go through a new underwriting process. Universal life insurance includes a cash value. Premiums increase the cash values, but the cost of insurance and any other charges assessed by the insurance company reduces the cash values. Also, for example, many riders are available to supplement policies, e.g., return of premium riders or return of cash value riders as well as accelerated death benefits that is available upon a significant change of health that clearly affects life expectancy.

Variable life insurance is a form of universal life insurance that permits the policy holder to invest a portion of their premium payments in securities, e.g., such as funds like mutual funds, S&P funds, etc., across a variety of separate accounts. The death benefit provided to the designated beneficiary upon the insured individual's death and the cash value of the policy may vary depending on the performance of the variable life investments.

An offshoot of universal life insurance is indexed universal life insurance. An index universal life insurance policy (index policy) provides the policy holder with the opportunity to allocate cash value amounts to either a fixed account or an equity index account. For example, index policies offer a variety of popular index funds to allocate selected percentages of the cash value amount, such as the S&P 500 and the Nasdaq 100. One advantage of an index policy is that it typically guarantees the principal amount invested in the indexed portion, but caps the maximum return that a policy holder can receive from the investment account. Another exemplary advantage of an index universal life insurance policy is that index policies are generally inexpensive as compared to other insurance policies, e.g., due to lack of management costs, and are considered ‘safer’ than most variable universal life insurance policies. Yet, an index policy has limited upside potential as compared to variable life insurance policies.

### SUMMARY

Techniques, systems, and devices are disclosed for managing investment and insurance policies including processes for monitoring insurance policies and their status in connection with distribution of investment and other insurance policy management actions. Software modules and data processing techniques are provided.

In one aspect, a method for managing a life insurance policy includes receiving, at a computer, information associated with a permanent life insurance policy and a policy holder of the permanent life insurance policy; analyzing, by a processor of the computer, the information by generating a rating value of the permanent life insurance policy; and determining, by the processor, if the rating value is above a predetermined minimum threshold value to admit the permanent life insurance policy into a policy optimization portfolio.

Implementations of the method can include one or more of the following exemplary features. For example, the permanent life insurance policy can include a whole life insurance policy, a universal life insurance policy, or a variable life insurance policy. For example, the information associated with the policy holder can include a medical history of the policy holder. In some implementations, for example, the method can further include providing a form to the policy holder containing prompts to solicit particular responses by the policy holder to obtain the information. In some implementations of the method, for example, the generating the rating value includes performing one or more calculations using at least some of the received information. In one example, the one or more calculations can include dividing the age of the policy holder by the cash value of the permanent life insurance policy to generate a quotient, multiplying the quotient by the amount of the death benefit of the permanent life insurance policy to generate a product, and multiplying the product by a multiplier value to generate the rating value. In some implementations, for example, the multiplier value can include a larger quantitative value based on an older age. In some implementations, for example, the one or more calculations can further include multiplying the generated rating value by a discount rate based on a demographic factor of the policy holder.

The method can further include a method for creating financial value using the admitted permanent life insurance policies of the policy optimization portfolio, for example, in which the financial value creation method includes obtaining investment funding from a financial institution based on a cash value of one or more of one admitted permanent life insurance policies; investing at least some of the investment funding in one or more financial markets to receive a financial return; and determining, by the processor, a distribution of the financial return to provide to the policy holder and the financial institution. In some implementations of the financial value creation method, for example, the obtaining the investment funding includes one or both of (i) collateralizing at least a portion of the cash value of the one or more of one admitted permanent life insurance policies with the financial institution; and (ii) leveraging at least a portion of the cash value of the one or more of one admitted permanent life insurance policies with the financial institution, in which the financial institution provides backing of the investment funding based on the cash value leveraging.

In one aspect, a method for managing a life insurance policy includes receiving, at a computer system of one or more computers, information associated with a permanent life insurance policy and a policy holder of the permanent life insurance policy, in which the information includes an age of the policy holder, a medical history of the policy holder, a cash value of the permanent life insurance policy, and a death benefit of the permanent life insurance policy; analyzing, by the computer system, the received information to generate a rating value of the permanent life insurance policy, in which the generating the rating value includes (i) determining a multiplier value associated with the individual policy holder based on the age and medical history data of the policy holder, and (ii) calculating the rating value by dividing the age of the policy holder by the cash value of the permanent life insurance policy to generate a quotient, multiplying the quotient by the amount of the death benefit of the permanent life insurance policy to generate a product, and multiplying the product by the multiplier value to generate the rating value; admitting, by the computer system, the permanent life insurance policy into a policy optimization portfolio if eligible based on a determination that the rating value associated with the permanent life insurance policy is above a predetermined minimum threshold value, in which the policy optimization portfolio includes one or more admitted permanent life insurance policies; and generating a financial value, by the computer system, using the admitted permanent life insurance policies of the policy optimization portfolio, in which the creating includes: (i) obtaining investment funding from a financial institution based on cash values of the admitted permanent life insurance policies by collateralizing at least a portion of the cash values with the financial institution, and leveraging at least a portion of the cash values with the financial institution, such that the financial institution provides backing of the investment funding based on the leveraged cash value portion, (ii) investing at least some of the investment funding in one or more financial markets to receive a financial return, and (iii) determining a distribution of the financial return to provide to the policy holder and the financial institution.

In one aspect, a system for managing a life insurance policy includes one or more computers in communication with a remote computer device via a communication network or link, in which the one or more computers are configured to determine a rating value of a permanent life insurance policy by analyzing information associated with the permanent life insurance policy and a policy holder of the permanent life insurance policy, and in which the one or more computers are configured to determine if the rating value is above a predetermined minimum threshold value to admit the permanent life insurance policy into a policy optimization portfolio.

Implementations of the system can include one or more of the following exemplary features. In some implementations, for example, the one or more computers can be further configured to perform one or more calculations using at least some of the information to generate the rating value; for example, in which the one or more calculations can include dividing the age of the policy holder by the cash value of the permanent life insurance policy to generate a quotient, multiplying the quotient by the amount of the death benefit of the permanent life insurance policy to generate a product, and multiplying the product by a multiplier value to generate the rating value; and, for example, in which the multiplier value can include a larger quantitative value based on an older age. For example, the one or more calculations can further include multiplying the generated rating value by a discount rate based on a demographic factor of the policy holder. In some implementations, for example, the one or more computers can be further configured to generate a financial gain using the admitted permanent life insurance policies of the policy optimization portfolio by: managing the obtaining of investment funding from a financial institution based on a cash value of one or more of the admitted permanent life insurance policies; managing the investing of at least some of the investment funding in one or more financial markets to receive a financial return; and determining a distribution of the financial return to provide to the policy holder and the financial institution, in which the managing the obtaining of investment funding includes one or both of: collateralizing at least a portion of the cash value of the one or more of the admitted permanent life insurance policies with the financial institution, and leveraging at least a portion of the cash value of the one or more of the admitted permanent life insurance policies with the financial institution, in which the financial institution provides backing of the investment funding based on the cash value leveraging. For example, the permanent life insurance policy can include a whole life insurance policy, a dividend-paying whole life insurance policy, a universal life insurance policy, an indexed universal life insurance, a variable life insurance policy, an annuity contract, or any other equivalent or combinations of products underwritten and issued by an insurance company or any other financial institution (e.g., such as a policy that has a combination of two or more of life benefits, health benefits, annuity benefits and/or living benefits). For example, the information associated with the policy holder includes a medical history of the policy holder.

In one aspect, a system for managing life insurance policies for investment includes a communication network including computers or servers, one or computers or servers in the network being in communication with a remote computer device via the communication network. The one or computers or servers in the network are configured to include an insurance policy evaluation module that determines a rating value of a permanent life insurance policy by analyzing information associated with the permanent life insurance policy and a policy holder of the permanent life insurance policy, and further determines whether the rating value is above a predetermined minimum threshold value to admit the permanent life insurance policy into a policy optimization portfolio. The one or computers or servers in the network are configured to include an investment management module that manages admitted permanent life insurance policies in the policy optimization portfolio, the investment management module operable to obtain investment funding from a financial institution based on a value of one or more of the admitted life insurance policies, invest at least some of the investment funding in one or more financial markets to receive a financial return, and determine a distribution of the financial return to provide to the policy holder and the financial institution.

Implementations of the system can include one or more of the following exemplary features. In some implementations, for example, the insurance policy evaluation module can be further configured to perform one or more calculations using at least some of the information to generate the rating value; for example, in which the one or more calculations can include dividing the age of the policy holder by the cash value of the permanent life insurance policy to generate a quotient, multiplying the quotient by the amount of the death benefit of the permanent life insurance policy to generate a product, and multiplying the product by a multiplier value to generate the rating value; for example, in which the multiplier value can include a larger quantitative value based on an older age; and, for example, in which the one or more calculations further can include multiplying the generated rating value by a discount rate based on a demographic factor of the policy holder. In some implementations, for example, the investment management module can be further configured to generate a financial gain using the admitted permanent life insurance policies of the policy optimization portfolio, and in which the obtaining of investment funding includes collateralizing at least a portion of the cash value of the one or more of the admitted permanent life insurance policies with the financial institution, or leveraging at least a portion of the cash value of the one or more of the admitted permanent life insurance policies with the financial institution, in which the financial institution provides backing of the investment funding based on the cash value leveraging. For example, the permanent life insurance policy can include a whole life insurance policy, a dividend-paying whole life insurance policy, a universal life insurance policy, an indexed universal life insurance, a variable life insurance policy, or an annuity contract. For example, the information associated with the policy holder can include a medical history of the policy holder.

Those and other features are described in greater detail in the drawings, the description and the claims.

### BRIEF DESCRIPTION OF THE DRAWINGS

FIG. 1A shows a diagram of an exemplary embodiment of a life insurance policy optimization program (POP).

FIG. 1B shows a diagram of another exemplary embodiment of the POP.

FIG. 2A shows a flow diagram of an exemplary POP policy evaluation process.

FIG. 2B shows a block diagram of an exemplary permanent life insurance policy evaluation process.

FIG. 3A shows an exemplary Policy Information and Assessment (PIA) form used in the exemplary POP policy evaluation process.

FIG. 3B shows an exemplary medical history information form used in the exemplary POP policy evaluation process.

FIG. 4 shows an example of a communication network for implementing the disclosed technology in managing life insurance policies for investment.

### DETAILED DESCRIPTION

Investment life insurance policies including whole life insurance have several advantages over protection life insurance like the term life insurance, which include guaranteed death benefits, guaranteed cash values, fixed, predictable annual premiums, and expense charges that typically do not reduce the cash value of the policy. Yet, among the advantages of building guaranteed cash value in the policies lie some shortcomings. For example, the typical internal rate of return in an investment life insurance policy may not be competitive with other investment and savings alternatives.

Presently, communications between insurance companies, financial institutions (e.g., investment banks), and the individual policy holders lack a centralized computer system to manage data collection, analysis, and instructions to evaluate and monetize existing and new permanent life insurance policies. For example, individual users of these entities may communicate such data between servers and client computers over a multiple data communication networks connected in various ways over the Internet. Each aggregation, analysis, and communication event requires an individual user or group to manually send the data to manually selected recipients, often to solicit more information, which thereby continues to cost additional computer resources and time. Moreover, coordinating the data collection, analysis, and instructions to evaluate and/or monetize such life insurance policies typically requires each of the individual users associated with the insurance companies, financial institutions, and the policy holders to have a high level of expertise and knowledge to perform at each stage of the processes. The overall process is highly inefficient not only to the individual users of these entities in terms of their time that must be spent to analyze data and generate communications specific to the intended recipient(s), but also inefficient with respect to resources utilized on the communication network and computer systems.

In one aspect, techniques, systems, and devices are disclosed for analyzing and managing existing life insurance policies and financial investments using value of the life insurance policies, referred to herein as a life insurance policy optimization program (POP). The POP manages both life insurance policies and investments based on evaluated life insurance policies entered in the program. Examples of POP management systems as disclosed can include computer-implemented software modules and data processing methods to, among others, enable computer-implemented processes that evaluate the life insurance policy, e.g., including determining eligibility into the POP and assigning a rating value. The POP management systems can include computer-implemented processes that recommend courses of action for the policy holders or the POP system to take with respect to the life insurance policies based on a POP evaluation process. The POP management systems can include computer-implemented processes that provide policy servicing actions for the permanent life insurance policy. The POP management systems can include computer-implemented processes that manage investments in financial markets with respect to value of the permanent life insurance policy determined by a POP evaluation process. The POP management systems can also include computer-implemented processes that market and promote the POP.

Currently, insurance companies make money by maintaining excess returns over and above what they credit to their policy holders. The POP allows the policy holder to utilize this underperforming asset of their life insurance policy. In the POP, an existing life insurance policy is easily and safely leveraged by a POP management system so that investment potential of the life insurance policy is fully maximized, thereby benefiting the policy holder. For example, by a policy holder participating in the POP, the “value” of the permanent life insurance policy asset can be “reclaimed” by the policy holder for leveraging and/or other purposes. In some implementations, the POP does not alter the death benefit of the life insurance policy, which is maintained with all rights for the designated beneficiary or beneficiaries. The POP invests money based on the cash values of eligible life insurance policies in the POP as investment to produce financial returns to the policy holders, as well as the POP manager and any other participating institutions. Policies that qualify for the POP will have many options for using the proceeds from financial gains produced by the POP. For example, one option includes payment toward any future required premium payments in an effort to maintain the viability of the policy. Other exemplary options can include future lump sum distributions to the policy holder. In addition to financial returns on investment, the POP provides several other benefits to the policy holder including policy holder protection by periodic examinations of the policy.

Moreover, the POP provides increases in efficiency of computing and data communication resources on computer systems of users for each entity at each stage. For example, the POP provides a centralized computer system to collect and analyze data and perform actions based on the analyzed data that reduces excess computational resources on the client and server computers of the insurance companies, financial institutions, and individual policy holders, as well as reduces network traffic that in turn increases efficiencies on the communication infrastructure of the Internet. Such increased efficiencies are created while also creating wealth and reducing the complexities associated with the present life insurance marketplace.

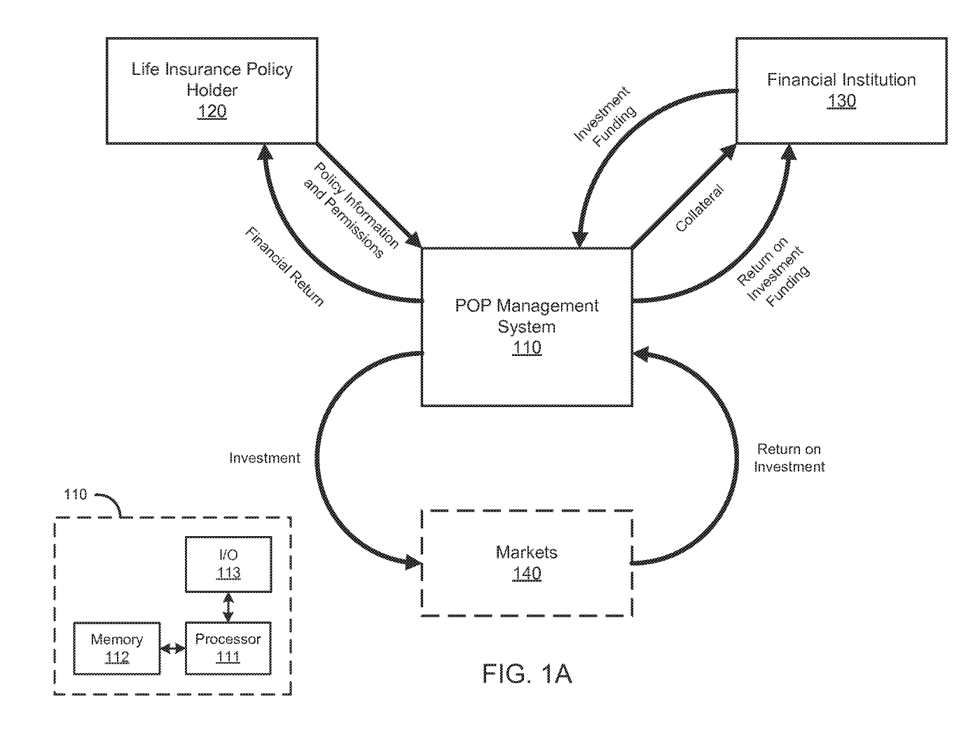

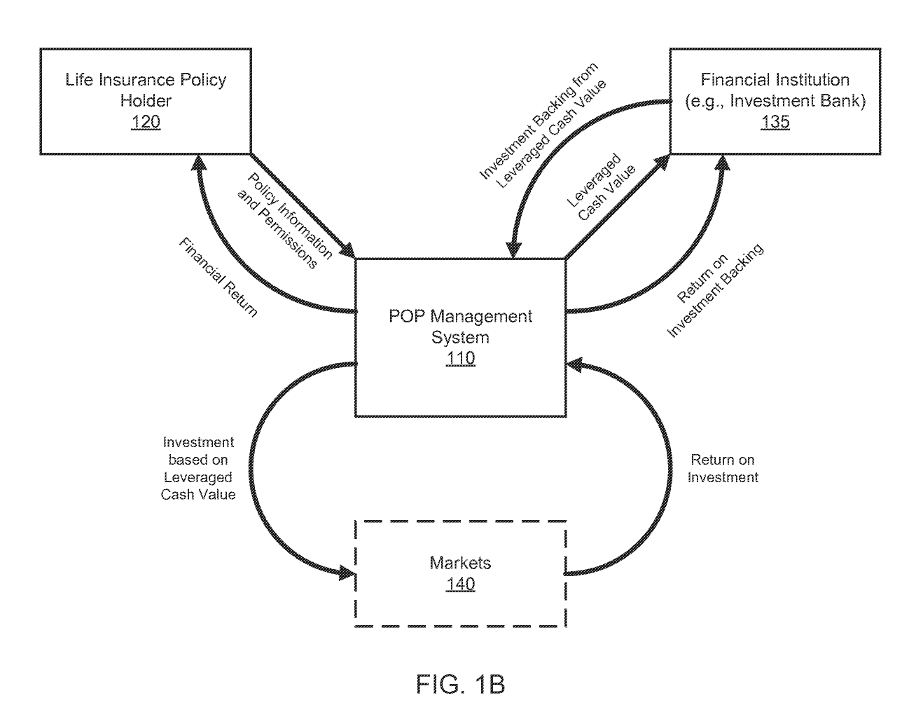

FIG. 1A shows a diagram of an exemplary embodiment of a life insurance policy optimization program (POP) to analyze existing life insurance policies and manage financial investments using value of the life insurance policies. The POP includes a POP management system 110 including one or more computer systems that can evaluate life insurance policies and determine a ranked value of the life insurance policy used to determine an investment strategy and process. A computer system(s) of the POP management system 110 includes a processor 111 to process data and a memory unit 112 in communication with the processor 111 to store data. The computer system(s) of the POP management system 110 includes an input/output (I/O) unit 113 in communication with the processor 111 that provides wired and/or wireless interfaces compatible with typical data communication standards for communication of the POP management system 110 with other computer systems, or external interfaces, sources of data storage, or display devices, among others. For example, the memory unit 112 can include processor-executable code, which when executed by the processor 111, configures the computer system(s) of the POP management system 110 to perform various operations, such as receiving information, commands, and/or data, processing information and data, and transmitting or providing information/data to another entity or to a user. For example, the I/O unit 113 can provide wired or wireless communications using one or more of the following communications standards, e.g., including, but not limited to, Universal Serial Bus (USB), IEEE 1394 (FireWire), Bluetooth, IEEE 802.111, Wireless Local Area Network (WLAN), Wireless Personal Area Network (WPAN), Wireless Wide Area Network (WWAN), WiMAX, IEEE 802.16 (Worldwide Interoperability for Microwave Access (WiMAX)), 3G/4G/LTE cellular communication methods, and parallel interfaces, among others. In some implementations of the system, the POP management system 110 can be implemented by one or more centralized computer systems or by a communication network accessible via the Internet (referred to as ‘the cloud’) that includes one or more remote computational processing devices (e.g., servers in the cloud).

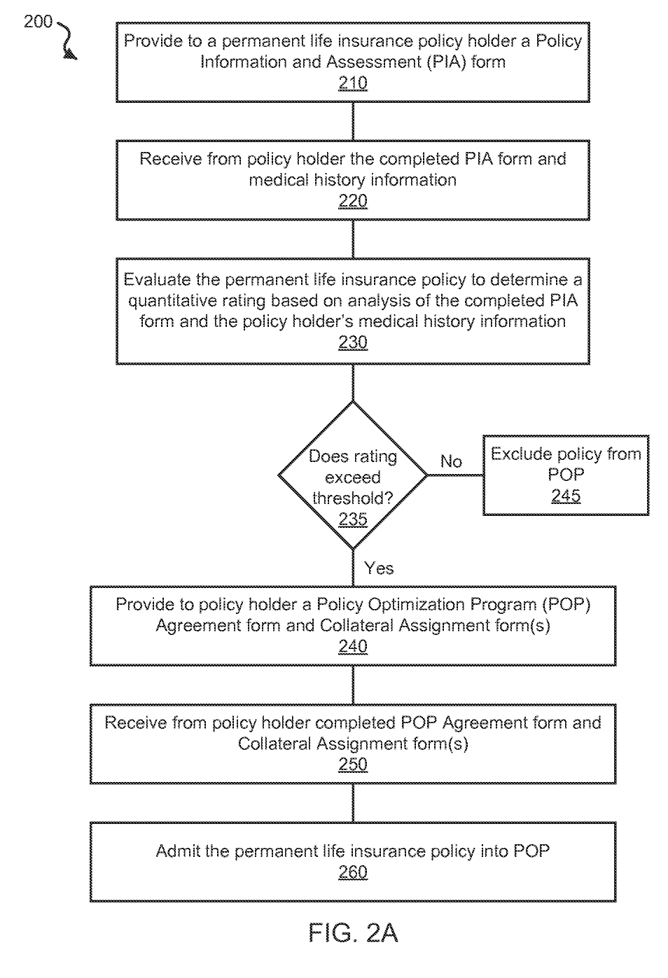

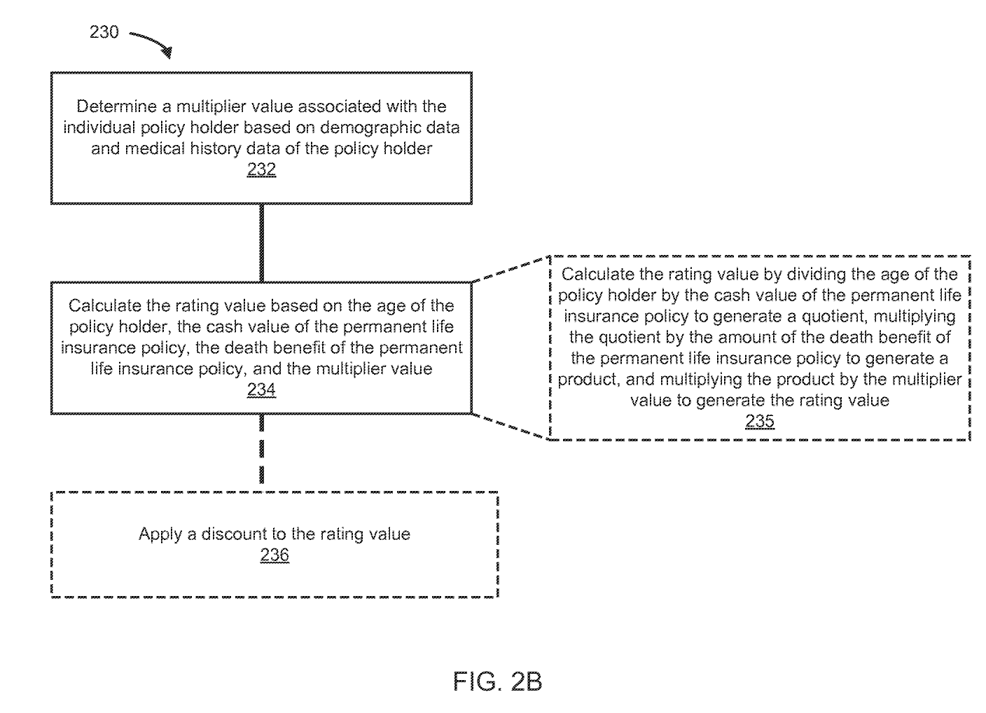

As shown in FIG. 1A, the POP management system 110 is configured to receive information on a life insurance policy, permissions, and financial fees from a life insurance policy holder 120. The POP management system 110 is configured to transmit information and financial returns to the life insurance policy holder 120. In some implementations, for example, the financial returns can include premium financing returns. For example, the POP management system 110 can implement a life insurance policy evaluation process to determine eligibility and rank of an existing permanent life insurance policy submitted to the POP management system 110 by the life insurance policy holder 120, described later in FIGS. 2A and 2B.

As shown in FIG. 1A, the POP management system 110 is configured to put up collateral to one or more financial institutions 130 to receive investment funding that can be invested by the POP management system 110 in various investment markets 140. In some implementations, for example, the POP management system 110 is configured to utilize the cash values of POP participating life insurance policies as the collateral for receiving investment funding from the one or more financial institutions 130. In some implementations, for example, the POP management system 110 is configured to utilize the POP participating life insurance policies as the collateral for receiving investment funding from the one or more financial institutions 130. The POP management system 110 is configured to invest the investment funding in one or more of the investment markets 140 to generate financial returns on the investment. For example, the POP management system 110 provides the financial institution(s) 130 with an Investment Provisions form that describes terms and information related to their return on investment funding that will be provided to the financial institution(s) 130 based on the generated financial return received by the POP management system 110 from investments in the market 140. For example, the Investment Provisions form can outline a predetermined return rate or variable rate of return on the financial institution's 130 return on investment funding based on various investment parameters. Also, for example, a suitability form can be provided by the POP management system 110 to the financial institution(s) 130, e.g., the investment fund which originates from the investor/client.

FIG. 1B shows another exemplary embodiment of the POP, where in addition or as an alternative to collateralizing the cash values of the POP participating life insurance policies, the POP management system 110 can leverage the cash values of the POP participating life insurance policies backed by one or more financial institutions 135 (e.g., such as investment banks) to invest money based on the leveraged cash values in the various investment markets 140. For example, the POP management system 110 provides the financial institution(s) 135 with a Leverage Provisions form that describes terms and information related to their return on investment that will be provided to the financial institution(s) 135 based on the generated financial return received by the POP management system 110 from investments in the market 140. For example, the POP management system 110 can provide information and/or forms to the financial institution(s) 135 that outlines suitability, risk factors, and investment opportunities that can influence types of investments made based on the leveraged cash values in the various investment markets 140. As in the embodiment shown in FIG. 1A, the POP management system 110 shown in FIG. 1B is also configured to receive information on a life insurance policy, permissions, and financial fees from a life insurance policy holder 120, transmit information and financial returns to the life insurance policy holder 120, and implement the life insurance policy evaluation processes of existing permanent life insurance policies submitted to the POP management system 110 by the life insurance policy holder 120.

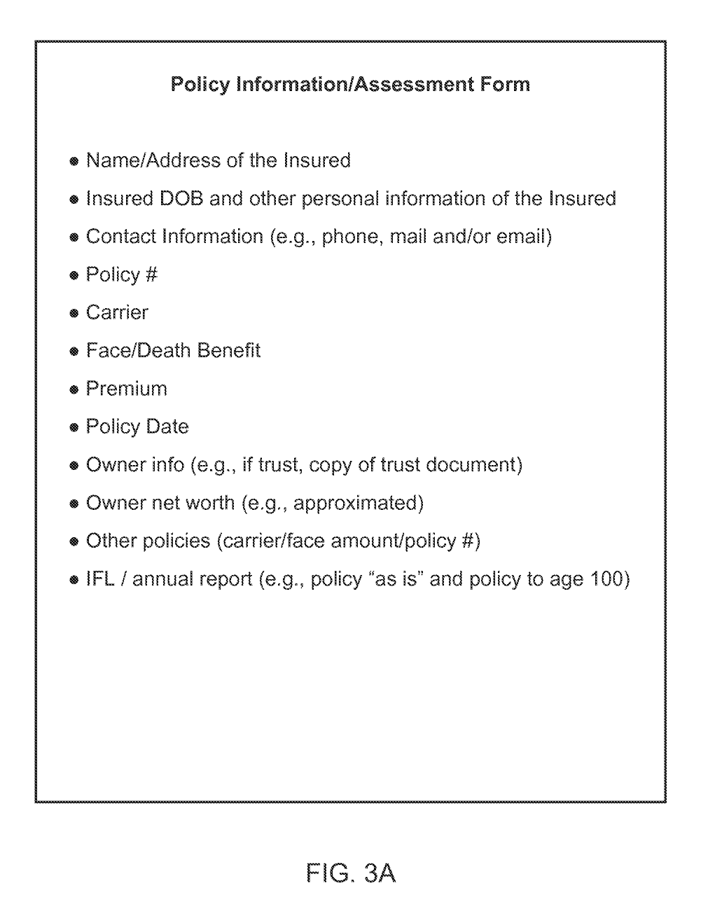

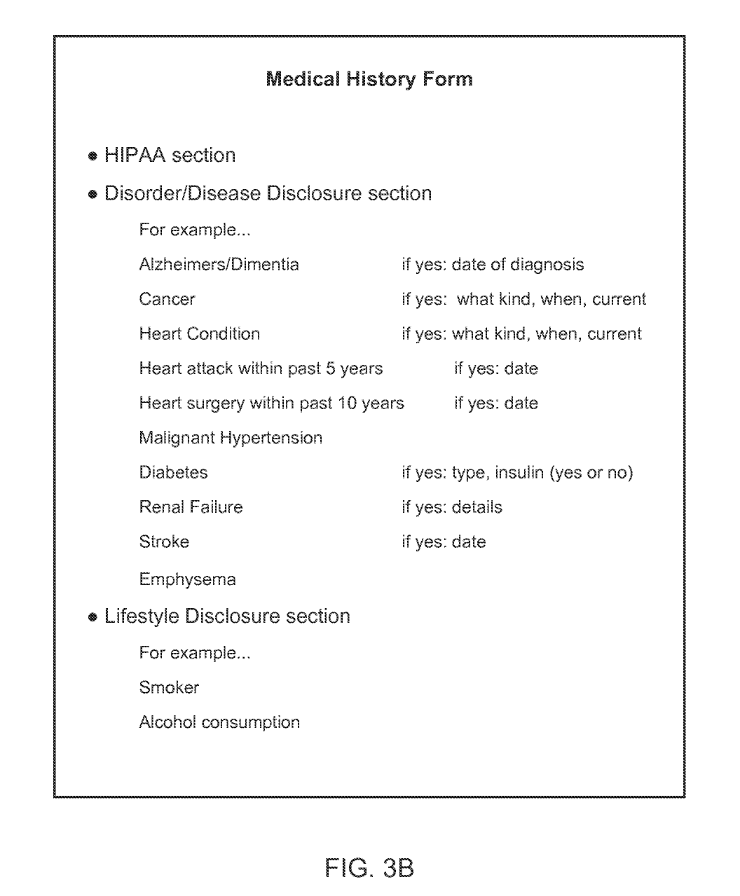

FIG. 2A shows a flow diagram of an exemplary POP policy evaluation process 200 implemented by the POP management system 110. The POP policy evaluation process 200 includes a process 210 to provide a Policy Information and Assessment (PIA) form to the permanent life insurance policy holder 120. For example, a framework of an exemplary PIA form is shown in FIG. 3A, in which the exemplary PIA form includes a variety of information categories about the insured and the policy to be filled out/completed. The exemplary PIA form can include some or all of the following information, but is not limited to: Name and Address of the insured; Date of Birth and other personal information of the insured; Contact Information of the insured; Policy Number of the permanent life insurance policy to be evaluated by the POP management system 110; Life Insurance Carrier information; Face Value and/or Death Benefit of the permanent life insurance policy; Premium and/or Payment information of the permanent life insurance policy; Policy Date to when the policy was enacted; Owner Information (e.g., if a trust, a copy of the trust document may be required); Approximate or Estimated Net Worth; and information on other policies (e.g., including some or all of the information required on the PIA for the permanent life insurance policy under evaluation). In some implementations, for example, the exemplary PIA form can include request for an IFL/annual report (e.g., policy “as is” and policy to age 100).

In some implementations of the process 210, for example, a medical history information form is provided to the permanent life insurance policy holder 120 to be filled out/completed. FIG. 3B shows a framework of an exemplary Medical History information form used in the exemplary POP policy evaluation process 200. The exemplary Medical History information form can include some or all of the following sections, but is not limited to: a section compliant with rules and regulations according to Health Insurance Portability and Accountability Act (HIPAA); a Disorder and Disease Disclosure section, e.g., including a questionnaire on a variety of health conditions, diseases, medications being taken or having been taken, etc. by the policy holder; and a Lifestyle Disclosure Section, e.g., including a questionnaire on various lifestyle activities, habits, or behaviors are undertaken by the policy holder.

Referring back to FIG. 2A, the POP policy evaluation process 200 includes a process 220 to receive the completed PIA form and medical history information from the permanent life insurance policy holder 120. In some implementations, for example, the process 220 can also include receiving an in-force ledger (IFL)/annual report from the permanent life insurance policy holder 120.

The POP policy evaluation process 200 includes a process 230 to determine a rating value of the permanent life insurance policy including analysis by the POP management system 110 of the completed PIA form and medical history information completed by the policy holder. In some implementations, for example, analysis techniques of the process 230 include a comparative analysis of a ranked value or score of the permanent life insurance policy to that of a threshold or scale of thresholds. For example, as shown in a decision box 235 of FIG. 2A, if the analyzed life insurance policy value or score does not meet a minimum threshold, then the POP management system 110 implements a process 245 of the POP policy evaluation process 200 to exclude the analyzed life insurance policy from the Policy Optimization Program. Or, for example, if the analyzed life insurance policy value or score meets the minimum threshold, then the POP management system 110 implements a process 240 of the POP policy evaluation process 200 to provide the life insurance policy holder 120 a Policy Optimization Program Agreement form and Collateral Assignment form or forms. For example, in some implementations, the minimum threshold can include one or more evaluation parameters, e.g., such as a minimum cash value of the permanent life insurance policy (e.g., such as $1,000,000 face value or $100,000 cash value or $50,000 cash value if an annuity), or a minimum lifespan of the permanent life insurance policy (e.g., such as a 5 year old policy, unless a Section 1035 Exchange policy).

In some implementations of the process 230, for example, the POP management system 110 utilizes a policy evaluation software module to provide a quantitative rating or ranking of a permanent life insurance policy to be evaluated. The module can determine the quantitative rating value by performing one or more calculations using various parameters recorded on the PIA and/or medical history form. In one example, the module can calculate a rating value equal to the policy holder's Age divided by the Cash Value of the policy, multiplied by the amount of the Death Benefit, and multiplied by a multiplier value, as shown by Equation (1).

$$\frac{Age}{Cash Value} \times Death Benefit \times Multiplier \qquad ( 1 )$$

In general, for example, the lower the quantitative rating value, the better the life insurance policy. In some implementations, for example, the multiplier can be set to 1 for applicants at an age 50, after which the 0.1 is added to the multiplier for each year thereafter. The multiplier value is an important parameter of the exemplary rating value calculation because of the extremely high cost of insurance as one gets older, e.g., particularly into one's 70's and 80's. For example, an additional discount can be applied to the rating value for applicants of identified demographics based on reported statistical data, e.g., such as −15% discount to the rating value for female applicants. In implementations of the process 230, for example, the POP management system 110 can apply different required minimum thresholds based on the number of years for the loan commitment. For example, a rating value of 1500 or less would qualify for a 5 year loan, 1200 would qualify for a 7 year loan, 1000 or less would qualify for a 10 year loan.

FIG. 2B shows a block diagram of the process 230 of the exemplary POP policy evaluation process 200 implemented by the POP management system 110. For example, in some implementations, the process 230 can include a process 232 to determine a multiplier value associated with the individual policy holder based on demographic data and medical history data of the policy holder; and a process 234 to calculate the rating value based on the age of the policy holder, the cash value of the permanent life insurance policy, the death benefit of the permanent life insurance policy, and the multiplier value. In some implementations of the process 234, for example, the process 234 includes a process 235 that calculates the rating value by dividing the age of the policy holder by the cash value of the permanent life insurance policy to generate a quotient, multiplying the quotient by the amount of the death benefit of the permanent life insurance policy to generate a product, and multiplying the product by the multiplier value to generate the rating value, as shown in Eq. (1). In some implementations of the process 230, for example, the process 230 can further include a process 236 to apply a discount to the rating value. For example, the discount can be a percentage discount multiplied to the calculated rating value, or one of the parameters (e.g., age, a score or quantitative value based on the policy holder's medical history, cash value of the policy, etc.).

In some implementations, for example, the process 240 can include providing a Policy Servicing Subscription Agreement to the permanent life insurance policy holder 120 that includes one or more options to elect to permit the POP management system 110 to service a participating life insurance policy in the POP. Examples of policy servicing techniques include making premium payments; performing an annual policy evaluation (e.g., including request/review of IFL's) and producing annual projections of return; providing annual returns and tax documents to policy owners; and reviewing 1-3 year medical updates by the insured party for analysis. It is noted, for example, that in some implementations of the POP policy evaluation process 200, for some policies the process 230 and application of threshold 235 are not implemented.

The POP policy evaluation process 200 includes a process 250 to receive the completed Policy Optimization Program Agreement form and Collateral Assignment form or forms from the life insurance policy holder 120. The process 250 can include a verification process of the information provided in the Policy Optimization Program Agreement form and Collateral Assignment form or forms. For example, in some implementations, the process 250 can include receiving a signed Subscription Agreement (for policy servicing) from the permanent life insurance policy holder 120.

Upon completion of the process 250, a process 260 of the POP policy evaluation process 200 is implemented to admit the permanent life insurance policy into the Policy Optimization Program. For example, the process 260 can include presenting one or more of the following options to the policy holder, e.g., including a Section 1035 Exchange of Life Insurance Policy option to either a new life insurance policy or an annuity; a Life Settlement option; an identification of and option to correct policy errors and/or previously overlooked provisions (e.g., such as riders and other policy features); an option to reduce or increase current coverage; and an option to continue current coverage as-is. In some implementations of the process 260, POP policy maintenance requirements may also be presented. The POP policy evaluation process 200 can be repeated for reexamination of the life insurance policy on a predetermined basis, e.g., permitting renewal or cancellation of the participation of the admitted life insurance policy in the POP. For example, reexaminations can be set on a 1, 2, 5, 10, or 15 year basis, or based on other temporal or non-temporal events to trigger reexamination of the policy in the POP policy evaluation process 200. For example, POP evaluations and reexaminations are designed to protect the life insurance policies and prevent any kind of collateral call.

The POP management system 110 includes a plurality of software modules stored in the memory 112 and executed by the process 111 to manage various aspects of the POP. Some exemplary software modules of the POP management system can include, but are not limited to, a promotion module, a policy and policy holder information intake processing module, a policy evaluation processing module, a policy collateralization processing module, an investment management processing module, a client relations management (CRM) processing module, and data management processing module.

For example, the promotion module can provide marketing of the POP to a variety of institutions and individuals to benefit from the POP. Examples of promotion methods implemented by the promotion module include mass audience advertising via various media outlets, e.g., including web-based advertising and mobile applications, as well as personal advertising by insurance agents, investment advisors, certified public accountants (CPAs), tax attorneys and/or other attorneys, and other professionals.

For example, the life insurance policy and policy holder information intake processing module can manage receiving the policy information and medical history information from interested policy holders who submit their policy for the policy evaluation process, e.g., verifying if sufficient information has been provided and verifying veracity of the provided information.

For example, the policy evaluation processing module can analyze the information received by the intake processing module to determine a rating value and/or ranking that can indicate the viability and best use of the policy, e.g., including acceptance into or rejection from the POP. Also, the policy evaluation processing module can produce projections for future performance of the policy.

For example, the policy collateralization processing module can open one or more financial accounts for a participating policy once the policy is entered into the POP. For example, the policy collateralization processing module can submit a Collateralization form to the appropriate carrier. During the collateralization of the policy, the policy collateralization processing module can track the process until the collateralization is complete and provide the policy holder confirmation is received from the carrier

For example, the CRM processing module can manage all client information, e.g., including providing updated information including periodic statements to the participating policy holders 120 and financial institutions 130 and/or 135 about investment performance and policy analysis information. In some implementations, for example, the CRM processing module can provide the clients with investment statements, while statements on the policy assessment can be completed by a separate valuation system, e.g., in which fees may be charged to do so.

For example, the investment management processing module can control the funds received from the financial institutions 130 and/or 135 and how the funds are used as investments, e.g., how the investments are made and tracked. For example, the investment management processing module can control how much and when a financial return is provided to the policy holders 120 in the POP and how and when a return on investment is provided to the financial institutions 130 and/or 135. In some implementations, for example, the investment management processing module can manage funds that have not been used in a restrictive manner (e.g., create bonds). For example, excess funds can be directed by the POP management system 110 to interest bearing funds or other conservative investment, where they can remain until such time that they are drawn down and used in a selected investment pool or other type investment. The investment management processing module can be implemented to leverage the cash value of the policy, finance investment funding through loans or borrowing using the cash value of the policies as collateral, or create alternative financial instruments.

For example, the data management processing module can manage data stored in the memory unit 112 to provide cyber security and protect the data from privacy issues.

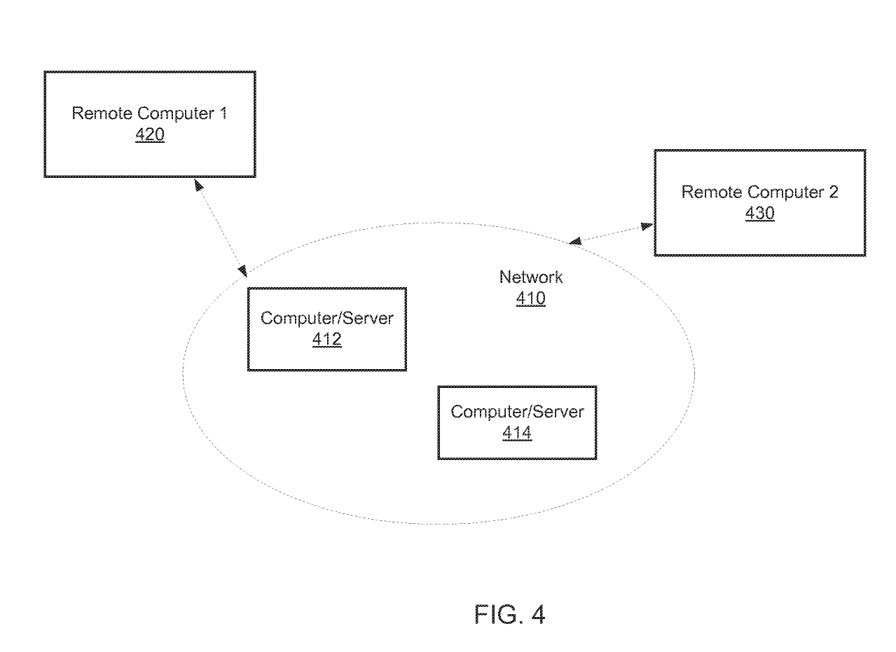

FIG. 4 shows an example of a communication network 410 for implementing the disclosed technology in managing life insurance policies for investment. The communication network includes computers or servers 412, 414 and communicates with remote computers, servers or computing devices 420, 430. The one or more computers or servers 412, 414 in the network 410 are configured to include an insurance policy evaluation module and an investment management module for managing life insurance policies and for making investment by using the cash values of managed life insurance policies as collaterals for getting investment funding to generate returns. The insurance policy evaluation module determines a rating value of a permanent life insurance policy by analyzing information associated with the permanent life insurance policy and a policy holder of the permanent life insurance policy, and further determines whether the rating value is above a predetermined minimum threshold value to admit the permanent life insurance policy into a policy optimization portfolio. The investment management module manages admitted permanent life insurance policies in the policy optimization portfolio, and obtains investment funding from a financial institution based on a value of one or more of the admitted life insurance policies. In addition, the investment management module invests a part or all of the investment funding in one or more financial markets to receive a financial return, and determines a distribution of the financial return to provide to the policy holder and the financial institution. To obtain the investment funding, the following processing can be implemented: using at least a portion of the cash value of the one or more of the admitted permanent life insurance policies as collaterals with the financial institution, or leveraging at least a portion of the cash value of the one or more of the admitted permanent life insurance policies with the financial institution so that the financial institution can provide backing of the investment funding based on the cash value. The one or more computers or servers 412, 414 in the network 410 can also be configured to include other modules described in this patent document.

In operation, for example, the remote computers 420, 430 can use the communication network 410 to remotely access the insurance policy evaluation module and/or the investment management module based on permissions associated with the type of user and the information to be exchanged between. For example, the remote computers 420, 430 be operated by clients of the POP management system, including, e.g., the policy holders, the financial institutions, and the insurance companies providing the permanent life insurance policies to the policy holders. For example, the policy holder clients can operate the remote computers 420, 430 to provide information associated with his/her permanent life insurance policy and himself/herself as a prospective applicant into the policy optimization program. The policy holder clients can operate the remote computers 420, 430 to receive information from the computers or servers 412, 414, e.g., including processed information and messages generated by the modules of the POP management system. For example, the insurance company clients can operate the remote computers 420, 430 to provide information associated with the permanent life insurance policy and the corresponding policy holder as an applicant into the policy optimization program. The insurance company clients can operate the remote computers 420, 430 to receive information from the computers or servers 412, 414, e.g., including processed information and messages generated by the modules of the POP management system. For example, the financial institution clients can operate the remote computers 420, 430 to provide information and received processed information associated with the financial transactions between the institution and the POP management system, e.g., such as information pertaining to collateral, leveraged cash values, investment funding, or returns on investment funding.

### Examples

The following examples are illustrative of several embodiments of the present technology. Other exemplary embodiments of the present technology may be presented prior to the following listed examples, or after the following listed examples.

In one example of the present technology (example 1), a method for managing a life insurance policy includes receiving, at a computer system of one or more computers, information associated with a permanent life insurance policy and a policy holder of the permanent life insurance policy, in which the information includes an age of the policy holder, a medical history of the policy holder, a cash value of the permanent life insurance policy, and a death benefit of the permanent life insurance policy; analyzing, by the computer system, the received information to generate a rating value of the permanent life insurance policy, in which the generating the rating value includes (i) determining a multiplier value associated with the individual policy holder based on the age and medical history data of the policy holder, and (ii) calculating the rating value by dividing the age of the policy holder by the cash value of the permanent life insurance policy to generate a quotient, multiplying the quotient by the amount of the death benefit of the permanent life insurance policy to generate a product, and multiplying the product by the multiplier value to generate the rating value; admitting, by the computer system, the permanent life insurance policy into a policy optimization portfolio if eligible based on a determination that the rating value associated with the permanent life insurance policy is above a predetermined minimum threshold value, in which the policy optimization portfolio includes one or more admitted permanent life insurance policies; and generating a financial value, by the computer system, using the admitted permanent life insurance policies of the policy optimization portfolio, in which the creating includes: (i) obtaining investment funding from a financial institution based on cash values of the admitted permanent life insurance policies by collateralizing at least a portion of the cash values with the financial institution, and leveraging at least a portion of the cash values with the financial institution, such that the financial institution provides backing of the investment funding based on the leveraged cash value portion, (ii) investing at least some of the investment funding in one or more financial markets to receive a financial return, and (iii) determining a distribution of the financial return to provide to the policy holder and the financial institution.

Example 2 includes the method of example 1, in which the permanent life insurance policy includes a whole life insurance policy, a dividend-paying whole life insurance policy, a universal life insurance policy, an indexed universal life insurance, a variable life insurance policy, or an annuity contract.

Example 3 includes the method of example 1, further including providing a form to the policy holder containing prompts to solicit particular responses by the policy holder to obtain the information.

Example 4 includes the method of example 1, in which the multiplier value is in a range of one to greater than zero.

Example 5 includes the method of example 1, in which the multiplier value increases based on an increasing age range.

Example 6 includes the method of example 1, in which the calculating the rating value further includes multiplying the generated rating value by a discount rate based on a demographic factor of the policy holder including one or more of gender, geographic location, or race.

In one example of the present technology (example 7), a method for managing a life insurance policy includes receiving, at a computer system of having one or more computers, information associated with a permanent life insurance policy and a policy holder of the permanent life insurance policy; analyzing, in the computer system, the received information to generate a rating value of the permanent life insurance policy; and determining, in the computer system, whether the rating value is above a predetermined minimum threshold value to admit the permanent life insurance policy into a policy optimization portfolio.

Example 8 includes the method of example 7, in which the permanent life insurance policy includes a whole life insurance policy, a dividend-paying whole life insurance policy, a universal life insurance policy, an indexed universal life insurance, a variable life insurance policy, or an annuity contract.

Example 9 includes the method of example 7, in which the information associated with the policy holder includes a medical history of the policy holder.

Example 10 includes the method of example 7, further including providing a form to the policy holder containing prompts to solicit particular responses by the policy holder to obtain the information.

Example 11 includes the method of example 7, in which the generating the rating value includes performing one or more calculations using at least some of the received information.

Example 12 includes the method of example 11, in which the one or more calculations includes dividing the age of the policy holder by the cash value of the permanent life insurance policy to generate a quotient, multiplying the quotient by the amount of the death benefit of the permanent life insurance policy to generate a product, and multiplying the product by a multiplier value to generate the rating value.

Example 13 includes the method of example 12, in which the multiplier value includes a larger quantitative value based on an older age.

Example 14 includes the method of example 12, in which the one or more calculations further includes multiplying the generated rating value by a discount rate based on a demographic factor of the policy holder.

Example 15 includes the method of example 7, further including creating financial value using the admitted permanent life insurance policies of the policy optimization portfolio, in which the creating includes: obtaining investment funding from a financial institution based on a cash value of one or more of the admitted permanent life insurance policies; investing at least some of the investment funding in one or more financial markets to receive a financial return; and determining a distribution of the financial return to provide to the policy holder and the financial institution.

Example 16 includes the method of example 15, in which the obtaining the investment funding includes one or both of collateralizing at least a portion of the cash value of the one or more of the admitted permanent life insurance policies with the financial institution; and/or leveraging at least a portion of the cash value of the one or more of the admitted permanent life insurance policies with the financial institution, in which the financial institution provides backing of the investment funding based on the cash value leveraging.

In one example of the present technology (example 17), a system for managing a life insurance policy includes one or more computers in communication with a remote computer device via a communication network or link, in which the one or more computers are configured to determine a rating value of a permanent life insurance policy by analyzing information associated with the permanent life insurance policy and a policy holder of the permanent life insurance policy, and in which the one or more computers are configured to determine if the rating value is above a predetermined minimum threshold value to admit the permanent life insurance policy into a policy optimization portfolio.

Example 18 includes the system of example 17, in which the permanent life insurance policy includes a whole life insurance policy, a dividend-paying whole life insurance policy, a universal life insurance policy, an indexed universal life insurance, a variable life insurance policy, an annuity contract, or any other equivalent or combinations of products underwritten and issued by an insurance company or any other financial institution (e.g., such as a policy that has a combination of two or more of life benefits, health benefits, annuity benefits and/or living benefits).

Example 19 includes the system of example 17, in which the information associated with the policy holder includes a medical history of the policy holder.

Example 20 includes the system of example 17, in which the one or more computers are further configured to perform one or more calculations using at least some of the information to generate the rating value.

Example 21 includes the system of example 20, in which the one or more calculations includes dividing the age of the policy holder by the cash value of the permanent life insurance policy to generate a quotient, multiplying the quotient by the amount of the death benefit of the permanent life insurance policy to generate a product, and multiplying the product by a multiplier value to generate the rating value.

Example 22 includes the system of example 21, in which the multiplier value includes a larger quantitative value based on an older age.

Example 23 includes the system of example 21, in which the one or more calculations further includes multiplying the generated rating value by a discount rate based on a demographic factor of the policy holder.

Example 24 includes the system of example 17, in which the one or more computers are further configured to generate a financial gain using the admitted permanent life insurance policies of the policy optimization portfolio by: managing the obtaining of investment funding from a financial institution based on a cash value of one or more of the admitted permanent life insurance policies; managing the investing of at least some of the investment funding in one or more financial markets to receive a financial return; and determining a distribution of the financial return to provide to the policy holder and the financial institution, in which the managing the obtaining of investment funding includes one or both of: collateralizing at least a portion of the cash value of the one or more of the admitted permanent life insurance policies with the financial institution, and leveraging at least a portion of the cash value of the one or more of the admitted permanent life insurance policies with the financial institution, in which the financial institution provides backing of the investment funding based on the cash value leveraging.

In one example of the present technology (example 25), a system for managing life insurance policies for investment includes a communication network including computers or servers, one or computers or servers in the network being in communication with a remote computer device via the communication network. The one or computers or servers in the network are configured to include an insurance policy evaluation module that determines a rating value of a permanent life insurance policy by analyzing information associated with the permanent life insurance policy and a policy holder of the permanent life insurance policy, and further determines whether the rating value is above a predetermined minimum threshold value to admit the permanent life insurance policy into a policy optimization portfolio. The one or computers or servers in the network are configured to include an investment management module that manages admitted permanent life insurance policies in the policy optimization portfolio, the investment management module operable to obtain investment funding from a financial institution based on a value of one or more of the admitted life insurance policies, invest at least some of the investment funding in one or more financial markets to receive a financial return, and determine a distribution of the financial return to provide to the policy holder and the financial institution.

Example 26 includes the system of example 25, in which the permanent life insurance policy includes a whole life insurance policy, a dividend-paying whole life insurance policy, a universal life insurance policy, an indexed universal life insurance, a variable life insurance policy, or an annuity contract.

Example 27 includes the system of example 25, in which the information associated with the policy holder includes a medical history of the policy holder.

Example 28 includes the system of example 19, in which the insurance policy evaluation module is further configured to perform one or more calculations using at least some of the information to generate the rating value.

Example 29 includes the system of example 28, in which the one or more calculations includes dividing the age of the policy holder by the cash value of the permanent life insurance policy to generate a quotient, multiplying the quotient by the amount of the death benefit of the permanent life insurance policy to generate a product, and multiplying the product by a multiplier value to generate the rating value.

Example 30 includes the system of example 29, in which the multiplier value includes a larger quantitative value based on an older age.

Example 31 includes the system of example 29, in which the one or more calculations further includes multiplying the generated rating value by a discount rate based on a demographic factor of the policy holder.

Example 32 includes the system of example 25, in which the investment management module is further configured to generate a financial gain using the admitted permanent life insurance policies of the policy optimization portfolio, and in which the obtaining of investment funding includes collateralizing at least a portion of the cash value of the one or more of the admitted permanent life insurance policies with the financial institution, or leveraging at least a portion of the cash value of the one or more of the admitted permanent life insurance policies with the financial institution, in which the financial institution provides backing of the investment funding based on the cash value leveraging.

Exemplary Annuity Contracts

In some aspects, the disclosed techniques, systems, and devices using the exemplary policy optimization program (POP) are implemented using annuity contracts.

An annuity contract is a financial contract between an annuity holder and a life insurance company where the annuity holder agrees to pays the insurance company a single premium or a flexible premium contribution plan that will be distributed back to the annuity holder over a period of time. Annuity contracts traditionally provide a guaranteed distribution of income over time, e.g., using fixed payments, until the death of the person or persons named in the contract or until a final date, whichever comes first. One advantage of annuity contracts currently is that annuity holders can use their annuities only to accumulate financial gains that are non-taxable (e.g., free of income and capital gains taxes), as well as take lump-sum withdrawals.

Generally, there are two phases for an annuity contract. A deferral phase is when the annuity contract holder deposits and accumulates money into an account. The annuity income phase is when the annuity contract holder receives payments for some period of time. During the annuity income phase, the insurance company makes income payments that may be set for a stated period of time, e.g., such as five years, ten years, etc., or that may continue until the death of the annuity contract holder(s), e.g., also referred to as the annuitant(s) named in the contract. Annuitization over a lifetime can have a death benefit guarantee over a certain predetermined period of time, e.g., such as ten years. However, some annuity contracts may also be structured so that it has only the annuity phase, e.g., sometimes referred to as an immediate annuity.

The disclosed methods, systems, and devices can utilize annuity contracts as the permanent life insurance policies in the exemplary analyses performed by the POP manager for generate a rating value of an annuity contract and determining whether the rating value is above a predetermined minimum threshold value, e.g., to admit the annuity contract into a policy optimization portfolio. Furthermore, the disclosed methods, systems, and devices can be implemented to create financial value using the admitted annuity contracts of the policy optimization portfolio, e.g., by obtaining investment funding from a financial institution based on a value of one or more of the admitted annuity contracts in the portfolio, investing at least some of the investment funding in one or more financial markets to receive a financial return, and determining a distribution of the financial return to provide to the policy holder and the financial institution. For example, the investment funding can be obtained by collateralizing at least a portion of the value of the admitted annuity contract(s) with the financial institution, and/or leveraging at least a portion of the value of the admitted annuity contract(s) with the financial institution, in which the financial institution provides backing of the investment funding based on the value leveraging.

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

What is claimed is:

1. A method for managing a life insurance policy, comprising:
receiving, at a computer system of one or more computers, information associated with a permanent life insurance policy and a policy holder of the permanent life insurance policy, wherein the information includes an age of the policy holder, a medical history of the policy holder, a cash value of the permanent life insurance policy, and a death benefit of the permanent life insurance policy;
analyzing, by the computer system, the received information to generate a rating value of the permanent life insurance policy, wherein the generating the rating value includes (i) determining a multiplier value associated with the individual policy holder based on the age and medical history data of the policy holder, and (ii) calculating the rating value by dividing the age of the policy holder by the cash value of the permanent life insurance policy to generate a quotient, multiplying the quotient by the amount of the death benefit of the permanent life insurance policy to generate a product, and multiplying the product by the multiplier value to generate the rating value;
admitting, by the computer system, the permanent life insurance policy into a policy optimization portfolio if eligible based on a determination that the rating value associated with the permanent life insurance policy is above a predetermined minimum threshold value, wherein the policy optimization portfolio includes one or more admitted permanent life insurance policies; and
generating a financial value, by the computer system, using the admitted permanent life insurance policies of the policy optimization portfolio, wherein the creating includes: (i) obtaining investment funding from a financial institution based on cash values of the admitted permanent life insurance policies by collateralizing at least a portion of the cash values with the financial institution, and leveraging at least a portion of the cash values with the financial institution, such that the financial institution provides backing of the investment funding based on the leveraged cash value portion, (ii) investing at least some of the investment funding in one or more financial markets to receive a financial return, and (iii) determining a distribution of the financial return to provide to the policy holder and the financial institution.

2. The method of claim 1, wherein the permanent life insurance policy includes a whole life insurance policy, a dividend-paying whole life insurance policy, a universal life insurance policy, an indexed universal life insurance, a variable life insurance policy, or an annuity contract.

3. The method of claim 1, further comprising:
providing a form to the policy holder containing prompts to solicit particular responses by the policy holder to obtain the information.

4. The method of claim 1, wherein the multiplier value is in a range of one to greater than zero.

5. The method of claim 1, wherein the multiplier value increases based on an increasing age range.

6. The method of claim 1, wherein the calculating the rating value further includes:
multiplying the generated rating value by a discount rate based on a demographic factor of the policy holder including one or more of gender, geographic location, or race.

7. A method for managing a life insurance policy, comprising:
receiving, at a computer system having one or more computers, information associated with a permanent life insurance policy and a policy holder of the permanent life insurance policy;
analyzing, in the computer system, the received information to generate a rating value of the permanent life insurance policy; and
determining, in the computer system, whether the rating value is above a predetermined minimum threshold value to admit the permanent life insurance policy into a policy optimization portfolio.

8. The method of claim 7, wherein the permanent life insurance policy includes a whole life insurance policy, a dividend-paying whole life insurance policy, a universal life insurance policy, an indexed universal life insurance, a variable life insurance policy, or an annuity contract.

9. The method of claim 7, wherein the information associated with the policy holder includes a medical history of the policy holder.

10. The method of claim 7, further comprising:
providing a form to the policy holder containing prompts to solicit particular responses by the policy holder to obtain the information.

11. The method of claim 7, wherein the generating the rating value includes:
performing one or more calculations using at least some of the received information.

12. The method of claim 11, wherein the one or more calculations includes:
dividing the age of the policy holder by the cash value of the permanent life insurance policy to generate a quotient,
multiplying the quotient by the amount of the death benefit of the permanent life insurance policy to generate a product, and
multiplying the product by a multiplier value to generate the rating value.

13. The method of claim 12, wherein the multiplier value includes a larger quantitative value based on an older age.

14. The method of claim 12, wherein the one or more calculations further includes:
multiplying the generated rating value by a discount rate based on a demographic factor of the policy holder.

15. The method of claim 7, further comprising creating financial value using the admitted permanent life insurance policies of the policy optimization portfolio, wherein the creating includes:
obtaining investment funding from a financial institution based on a cash value of one or more of the admitted permanent life insurance policies;
investing at least some of the investment funding in one or more financial markets to receive a financial return; and
determining a distribution of the financial return to provide to the policy holder and the financial institution.

16. The method of claim 15, wherein the obtaining the investment funding includes one or both of:
collateralizing at least a portion of the cash value of the one or more of the admitted permanent life insurance policies with the financial institution; and
leveraging at least a portion of the cash value of the one or more of the admitted permanent life insurance policies with the financial institution, wherein the financial institution provides backing of the investment funding based on the cash value leveraging.

17. A system for managing a life insurance policy, comprising:
one or more computers in communication with a remote computer device via a communication network or link,
wherein the one or more computers are configured to determine a rating value of a permanent life insurance policy by analyzing information associated with the permanent life insurance policy and a policy holder of the permanent life insurance policy, and wherein the one or more computers are configured to determine if the rating value is above a predetermined minimum threshold value to admit the permanent life insurance policy into a policy optimization portfolio.

18. The system of claim 17, wherein the permanent life insurance policy includes a whole life insurance policy, a dividend-paying whole life insurance policy, a universal life insurance policy, an indexed universal life insurance, a variable life insurance policy, or an annuity contract.

19. The system of claim 17, wherein the information associated with the policy holder includes a medical history of the policy holder.

20. The system of claim 17, wherein the one or more computers are further configured to perform one or more calculations using at least some of the information to generate the rating value.

21. The system of claim 20, wherein the one or more calculations includes:
dividing the age of the policy holder by the cash value of the permanent life insurance policy to generate a quotient,
multiplying the quotient by the amount of the death benefit of the permanent life insurance policy to generate a product, and
multiplying the product by a multiplier value to generate the rating value.

22. The system of claim 21, wherein the multiplier value includes a larger quantitative value based on an older age.

23. The system of claim 21, wherein the one or more calculations further includes:
multiplying the generated rating value by a discount rate based on a demographic factor of the policy holder.

24. The system of claim 17, wherein the one or more computers are further configured to generate a financial gain using the admitted permanent life insurance policies of the policy optimization portfolio by:
managing the obtaining of investment funding from a financial institution based on a cash value of one or more of the admitted permanent life insurance policies;
managing the investing of at least some of the investment funding in one or more financial markets to receive a financial return; and
determining a distribution of the financial return to provide to the policy holder and the financial institution,
wherein the managing the obtaining of investment funding includes one or both of:
collateralizing at least a portion of the cash value of the one or more of the admitted permanent life insurance policies with the financial institution, and
leveraging at least a portion of the cash value of the one or more of the admitted permanent life insurance policies with the financial institution, wherein the financial institution provides backing of the investment funding based on the cash value leveraging.

25. A system for managing life insurance policies for investment, comprising:
a communication network including computers or servers, one or computers or servers in the network being in communication with a remote computer device via the communication network, wherein the one or computers or servers in the network are configured to include:
an insurance policy evaluation module that determines a rating value of a permanent life insurance policy by analyzing information associated with the permanent life insurance policy and a policy holder of the permanent life insurance policy, and further determines whether the rating value is above a predetermined minimum threshold value to admit the permanent life insurance policy into a policy optimization portfolio; and
an investment management module that manages admitted permanent life insurance policies in the policy optimization portfolio, the investment management module operable to obtain investment funding from a financial institution based on a value of one or more of the admitted life insurance policies, invest at least some of the investment funding in one or more financial markets to receive a financial return, and determine a distribution of the financial return to provide to the policy holder and the financial institution.

26. The system of claim 25, wherein the permanent life insurance policy includes a whole life insurance policy, a dividend-paying whole life insurance policy, a universal life insurance policy, an indexed universal life insurance, a variable life insurance policy, or an annuity contract.

27. The system of claim 25, wherein the information associated with the policy holder includes a medical history of the policy holder.

28. The system of claim 25, wherein the insurance policy evaluation module is further configured to perform one or more calculations using at least some of the information to generate the rating value.

29. The system of claim 28, wherein the one or more calculations includes:
dividing the age of the policy holder by the cash value of the permanent life insurance policy to generate a quotient,
multiplying the quotient by the amount of the death benefit of the permanent life insurance policy to generate a product, and
multiplying the product by a multiplier value to generate the rating value.

30. The system of claim 29, wherein the multiplier value includes a larger quantitative value based on an older age.

31. The system of claim 29, wherein the one or more calculations further includes:
multiplying the generated rating value by a discount rate based on a demographic factor of the policy holder.

32. The system of claim 25, wherein the investment management module is further configured to generate a financial gain using the admitted permanent life insurance policies of the policy optimization portfolio, and wherein the obtaining of investment funding includes:
collateralizing at least a portion of the cash value of the one or more of the admitted permanent life insurance policies with the financial institution, or
leveraging at least a portion of the cash value of the one or more of the admitted permanent life insurance policies with the financial institution, wherein the financial institution provides backing of the investment funding based on the cash value leveraging.

33. The system of claim 25, further comprising:
one or more client devices in communication with the one or computers or servers in the network to receive or provide information on behalf of a financial institution.

34. The system of claim 25, further comprising:
one or more client devices in communication with the one or computers or servers in the network to receive or provide information on behalf of an insurance policy holder.

35. The system of claim 25, further comprising:
one or more client devices in communication with the one or computers or servers in the network to receive or provide information on behalf of an insurance company.
